(19) United States
(12) Patent Application Publication
(10) Pub. No.: US 2007/0237361 A1
(43) Pub. Date: Oct. 11, 2007

(54) System and method for automated facility mapping and management

(75) Inventors: Ilan Sandor, Tivon (IL); Amir Kaldor, Atlit (IL)

Correspondence Address: DOCKETING SPECIALIST;SULLIVAN & WORCESTER LLP, ONE POST OFFICE SQUARE, BOSTON, MA, 02109, US

(73) Assignee: Columbus Application Provider Ltd., Yokneam (IL)

(21) Appl. No.: 11/402,179

(22) Filed: Apr. 11, 2006

(51) Int. Cl. G06K 9/00

(52) U.S. Cl. 382/104

(57) ABSTRACT

A system and a method for automatic facility management, including automatic analysis of at least one facility system according to at least one facility plan.

### FIELD OF THE INVENTION

The present invention relates to a system and a method for automated facility mapping and management, and in particular, to such a system and method in which at least one facility system is mapped automatically from a building plan.

### BACKGROUND OF THE INVENTION

Buildings have become increasingly complex to maintain, particularly large modern buildings such as skyscrapers. These buildings feature a plurality of different building systems, such as electricity, air conditioning and heating (temperature control; air conditioning, heating and ventilation are together referred to as HVAC systems), plumbing and so forth. These systems are interconnected, as air conditioning will not operate without electricity for example. Each must be maintained according to various rules and regulations, and also according to best practices, in order for the smooth operation of these systems to continue.

Automatic management of such building systems is clearly desirable over manual management. The systems are sufficiently complex that it is difficult if not impossible for a maintenance engineer to fully visualize them and to manually handle a huge amount of complex data. Furthermore, maintenance should be performed according to a particular schedule, in order to prevent malfunctions in one or more parts of the system.

Various software programs have been proposed and implemented in the art to overcome this problem. For example, Facility Navigator™ of Columbus Application Provider Inc (USA) is able to assist in the maintenance and management of building systems, once the plans for these building systems have been manually input. PCT Application No. WO 06/004649 to Siemens Building Technologies also describes software for management of building systems after the plans have been manually analyzed. However, all of these solutions clearly require manual analysis of the plans (blueprints) of the building and identification of objects therein, which can be disadvantageous in terms of the return on the investment of time and effort required. Manual analysis is time consuming and can also lead to human error. Automatic analysis methods in general have the advantage of being standardized and reproducible, and are therefore generally preferred. However, in this area, no such automated analysis methods are available.

### SUMMARY OF THE INVENTION

There is an unmet need for, and it would be highly useful to have, a system and a method for automated analysis and interpretation of facility plans for management of the facility.

There is also an unmet need for, and it would be highly useful to have, a system and a method for recommending facility maintenance schedule(s) according to automated analysis and interpretation of facility plans.

As defined herein, the term “facility” includes any building, group of buildings and/or structure or group of structures. Without limitation, a facility may optionally include a skyscraper, a factory, a plurality of buildings, an oil rig, an oil refinery, a power plant, a train system, a tunnel or underground road, hospital, university or airport.

According to preferred embodiments of the invention, there is provided a method for analyzing a facility plan, comprising: receiving the facility plan as an electronic drawing; identifying a plurality of objects in the facility plan to determine object identities; and automatically determining a relationship between the plurality of objects according to the object identities.

Preferably, the identifying the plurality of objects is performed manually. Alternatively, the identifying the plurality of objects is performed automatically.

Optionally, the automatically determining the relationship is performed according to a category of each object, the object identity comprising the category. Preferably, the category relates to a facility system.

Optionally, the identifying the objects comprising identifying text associated with each object and wherein the automatically determining the relationship comprises determining a relationship according to the text.

Also optionally, the identifying the objects comprising identifying a spatial location of each object and wherein the automatically determining the relationship comprises determining a spatial relationship between the objects according to the spatial locations. Preferably, the spatial relationship is determined according to a distance between the spatial locations.

Optionally, the automatically determining the relationship comprises determining a physical relationship between the plurality of objects.

Also optionally, the automatically determining the relationship comprises determining a logical relationship between the plurality of objects. Preferably, the method further comprises automatically determining connectivity between the plurality of objects according to the relationship. More preferably, the automatically determining the connectivity comprises identifying at least one facility system to which the plurality of objects belong. Most preferably, the automatically determining the connectivity comprises identifying a plurality of facility systems to which the plurality of objects belong and a connection between the plurality of facility systems.

According to other preferred embodiments of the present invention, there is provided a method for automatically analyzing a facility plan, comprising: receiving the facility plan as an electronic drawing; and automatically identifying a plurality of objects in the facility plan to determine object identities, wherein the automatically identifying the plurality of objects comprises at least one of automatically identifying an object category, text associated with each object, or a graphical element associated with each object. Preferably, the graphical element comprises at least one of an object template, a line type or a line color.

According to still other preferred embodiments of the invention, there is provided a method for automatically analyzing a facility plan, comprising: receiving the facility plan as an electronic drawing; determining a plan from the electronic drawing; analyzing the plan to determine at least one space; extracting a plurality of objects from the plan; identifying at least one object of the plurality of objects according to at least one rule; and correlating the identified object with a spatial location in the at least one space. Preferably, the identifying at least one object comprises identifying a plurality of objects, the method further comprising: correlating a relative spatial location of each of the plurality of identified objects. More preferably, the method further comprises comparing the relative spatial location to at least one rule; if the relative spatial location does not fit the at least one rule, re-identifying at least one object. Most preferably, the at least one rule comprises a rule modifier for determining a range of spatial locations.

Optionally, the method further comprises identifying text corresponding to the identified object; and extracting information about the identified object from the text. Preferably, the information is compared to the identified object according to at least one rule, such that if the information does not correspond to the at least one rule, the method further comprises re-identifying the object.

Optionally, the analyzing the plan further comprises identifying a plurality of layer of the plan from the electronic drawing; and wherein the identifying the at least one object comprises identifying the layer of the at least one object. Preferably, the at least one layer features a layer template, the layer template being identified according to at least one other object identification, wherein the at least one object is identified according to the layer template.

Optionally, the at least one rule comprises at least one of a line color or line type. Also optionally, the facility plan includes at least one facility system and wherein the identifying at least one object comprises identifying a plurality of objects, the method further comprising: determining a relationship between the plurality of objects; and identifying the plurality of objects as belonging to a facility system according to the relationship. Preferably, the relationship comprises a physical relationship, a logical relationship or a combination thereof.

Optionally, the facility plan comprises a plurality of facility systems, the method further comprising: identifying a plurality of objects as belonging to each of the plurality of facility systems; and identifying a relationship between the plurality of facility systems according to a relationship between a plurality of objects in the systems.

Also optionally, the facility plan includes at least one facility system and wherein the identifying at least one object comprises identifying a plurality of objects, the method further comprising: determining a relationship between the plurality of objects; comparing the relationship to at least one rule; identifying the relationship as an incorrect relationship; and determining a mis-identification for at least one object according to the incorrect relationship.

Preferably, the method further comprises: enabling a user to change at least one aspect of an object identification or a plan, or both.

Also preferably, the determining the plan further comprises: identifying at least one floor in the plan; determining a perimeter of the at least one floor according to a plurality of vectors. More preferably, the determining the perimeter further comprises: moving along the perimeter according to a first vector; if a further point is no longer available, determining whether an opening is available; and if an opening is not available, then moving along the perimeter according to a second vector, wherein the first vector and the second vector differ. Most preferably, the opening is available if a gap is present of less than a maximum size.

Optionally, the determining the perimeter further comprises: moving along the perimeter in a clockwise direction; and returning in a counterclockwise direction if the second vector is not available.

Also optionally, the determining the plan of at least one floor further comprises: comparing the perimeter to at least one rule; if the perimeter does not fit the at least one rule, rejecting the perimeter. Preferably, the at least one rule comprises an area range for the perimeter or a location of a fixed object within the perimeter. More preferably, the fixed object comprises at least one of an elevator, a stairwell or an atrium.

Optionally, the analyzing the plan comprises: determining a perimeter of at least one room according to a plurality of vectors.

According to still other preferred embodiments of the invention, there is provided a method for facility management, comprising: providing an electronic plan of a facility, the plan including at least one floor and at least one facility system; automatically analyzing the electronic plan to extract the at least one floor and a plurality of objects associated with the at least one facility system; and managing the facility system according to the analysis.

Preferably, the managing the facility system further comprises: determining a physical location where maintenance of the at least one facility system is to be performed in the facility.

Optionally, the automatically analyzing the electronic plan further comprises: identifying a plurality of objects; determining a relationship of the plurality of objects; and according to the relationship, identifying the at least one facility system to which the plurality of objects belong.

According to yet other preferred embodiments of the invention, there is provided a system for facility management, comprising: an analysis engine for automatically analyzing an electronic plan of a facility, the plan including at least one floor and at least one facility system; a system management module for recommending at least one action or displaying at least one object in the facility system according to the analysis; and a client connected to the system management module through a communication network, the client providing information about the at least one action and/or displaying the at least one object to a user.

According to preferred embodiments of the invention, there is provided a method for performing building commissioning on a facility, the facility comprising at least one system having available facility system comparison information, the method comprising: receiving a facility plan as an electronic drawing; automatically analyzing the electronic drawing to extract information about the facility system; and comparing the information about the facility system to the facility system comparison information. Preferably, the method further comprises determining at least one difference between the information about the facility system and the facility system comparison information; and displaying the at least one difference.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager. Any two or more of such devices in communication with each other, and/or any computer in communication with any other computer, may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic block diagram of an exemplary system according to the present invention, with FIG. 1A showing the overall system and FIG. 1B showing a part of the system in more detail;

FIG. 2 is an exemplary method according to the present invention;

FIG. 3 shows an exemplary flow process according to the present invention;

FIG. 4 shows an exemplary method for floor perimeter detection according to the present invention, with FIG. 4A showing the overall method, while certain aspects are described in more detail with regard to an exemplary floor perimeter plan in FIG. 4B;

FIGS. 5A and 5B are “before” (FIG. 5A) and “after” (FIG. 5B) illustrations of exemplary non-limiting building plan for the operation of the method according to the present invention;

FIGS. 6A and 6B show exemplary difficult aspects of the building plan of FIG. 5;

FIG. 7 shows an exemplary method for room detection according to the present invention, with FIG. 7A showing the method itself, while FIG. 7B relates to an illustrative example for using the method for detecting a room perimeter of an exemplary non-limiting room;

FIGS. 8A and 8B show exemplary difficult aspects of the building plan of FIG. 5 for room detection;

FIG. 9A shows an exemplary method for determining the relationship between a plurality of objects according to the present invention for a water connection;

FIG. 9B shows the water connection;

FIG. 10A shows an exemplary method for determining the relationship between a plurality of objects according to the present invention for an electrical connection;

FIG. 10B shows the electrical connection; and

FIG. 11 describes an exemplary method for building commissioning according to the present invention.

### DESCRIPTION OF THE PREFERRED EMBODIMENTS

The present invention is of a system and a method for automated analysis of at least one facility plan, thereby enabling management of at least one facility system, optionally and preferably including recommending at least one maintenance action for the at least one facility system. The system and method of the present invention enable facility infrastructure management to be performed more easily; furthermore, changes to the facility's structure and/or one or more facility systems may be more easily incorporated for automated management of the facility.

The system and method operate by analyzing a facility plan in order to detect a plurality of objects and their relationships. These objects are related to at least one building system, and preferably to a plurality of building systems. Preferably these objects are contained in a plurality of layers, although optionally only a single layer is present.

The present invention enables facility system information to be extracted automatically from facility plans. An exemplary method for adding a new facility plan to a database according to the present invention features a process that is at least partially automated. This process performs the most time consuming work of extracting (“understanding”) data from drawings in order to understand each element of the drawings alone and also in relation to other extracted items.

According to preferred embodiments of the present invention, the method for analyzing a facility plan starts by receiving the facility plan as an electronic drawing. Next, a plurality of objects in the facility plan are identified to determine object identities. Such an identification may optionally be performed automatically or manually. Also identification may optionally include identifying the category of the object and/or text associated with the object and/or a spatial location of the object. Optionally and preferably, the category relates to a facility system.

Next, a relationship between the plurality of objects is automatically determined according to the object identities. Such a relationship may optionally be determined according to any of the object identity information previously described, including but not limited to text associated with each object, the spatial locations of the objects (for example according to a distance between the objects) and so forth. The relationship may optionally be a physical relationship and/or a logical relationship between the plurality of objects.

Optionally and preferably, the method further comprises automatically determining connectivity between the plurality of objects according to the relationship, for example by identifying at least one facility system to which the plurality of objects belong. A plurality of such facility systems may also optionally be identified, such that a connection between the plurality of facility systems is also preferably determined.

According to other preferred embodiments of the present invention, there is provided a method for automatically analyzing a facility plan, which begins by receiving the facility plan as an electronic drawing. Next, a plurality of objects in the facility plan are automatically identified to determine object identities, according to at least one of automatically identifying an object category, text associated with each object, or a graphical element associated with each object. The graphical element optionally comprises at least one of an object template, a line type or a line color. An object template may optionally be determined according to a layer template, in which an object having a particular graphical element or symbol associated thereto is determined to have a particular identity according to the object template.

According to still other preferred embodiments of the present invention, there is provided a method for automatically analyzing a facility plan which also starts by receiving the facility plan as an electronic drawing. At least a portion of the plan is determined from the electronic drawing. The plan is analyzed to determine at least one space. A plurality of objects are then extracted from the plan and identified according to at least one rule. The identified object is correlated with a spatial location in the determined space.

The principles and operation of the present invention may be better understood with reference to the drawings and the accompanying description.

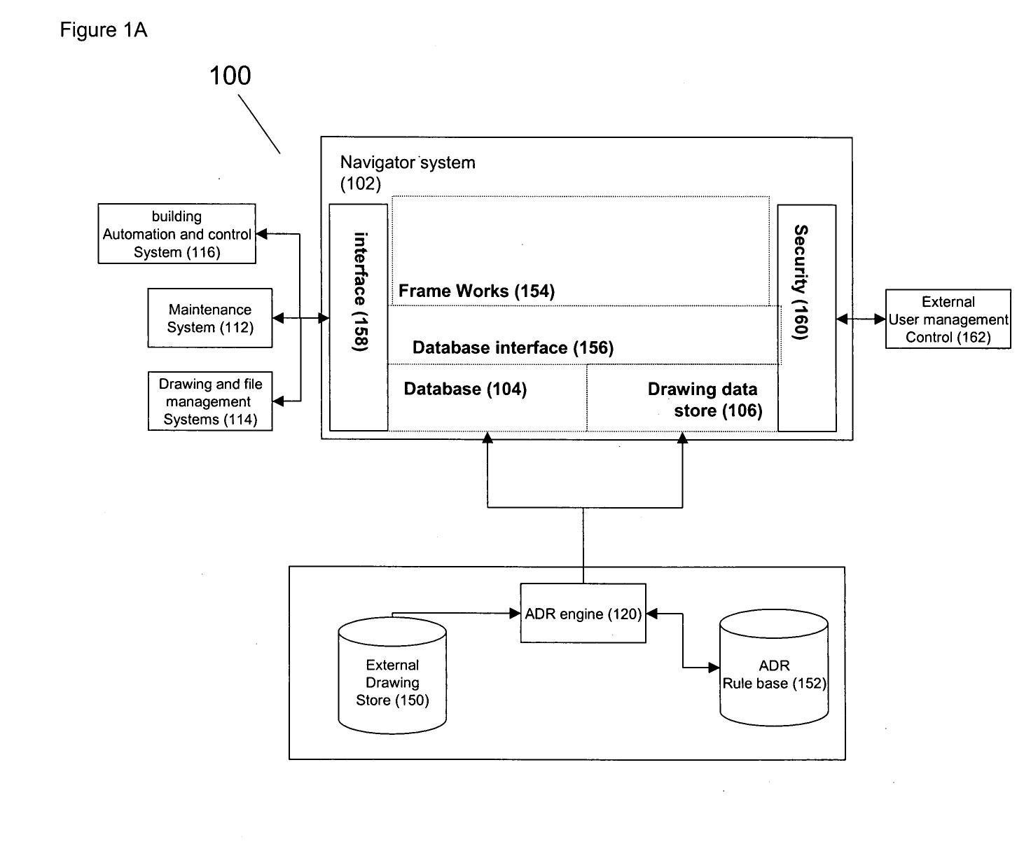

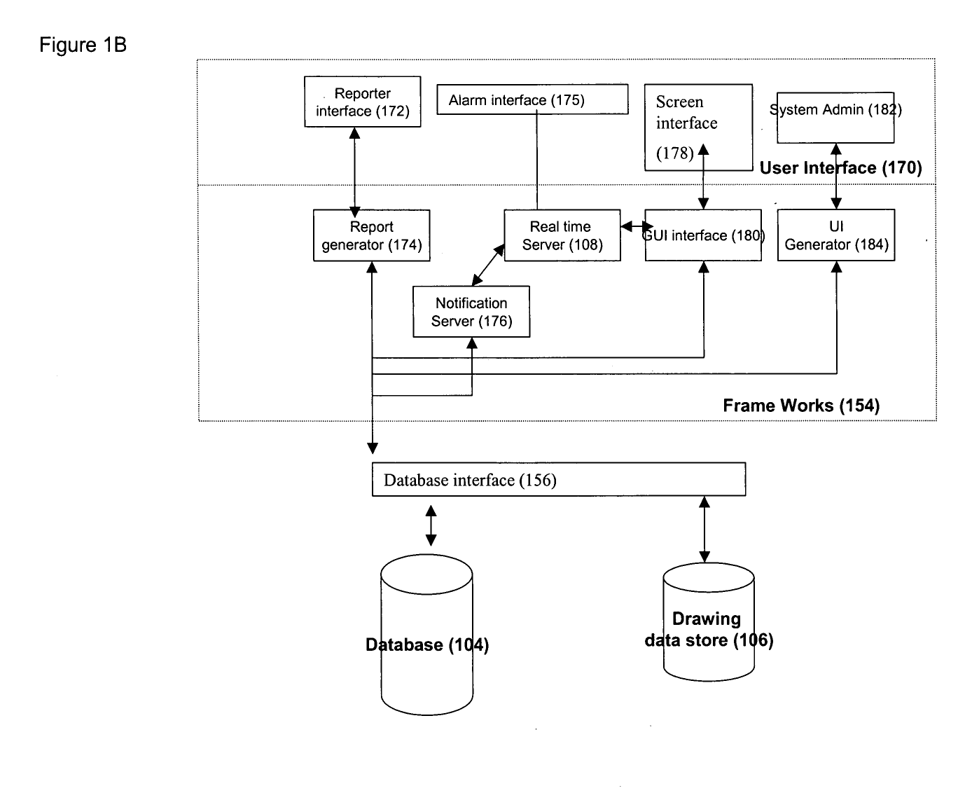

Referring now to the drawings, FIG. 1 is a schematic block diagram of an exemplary system according to the present invention for automatically analyzing a facility plan. The overall system is shown in FIG. 1A, while a portion of the system (related to the frameworks module) is shown in more detail in FIG. 1B. It should be noted that both FIGS. 1A and 1B are presented as logic diagrams; actual implementation of the systems shown herein according to these diagrams could easily be performed by one of ordinary skill in the art.

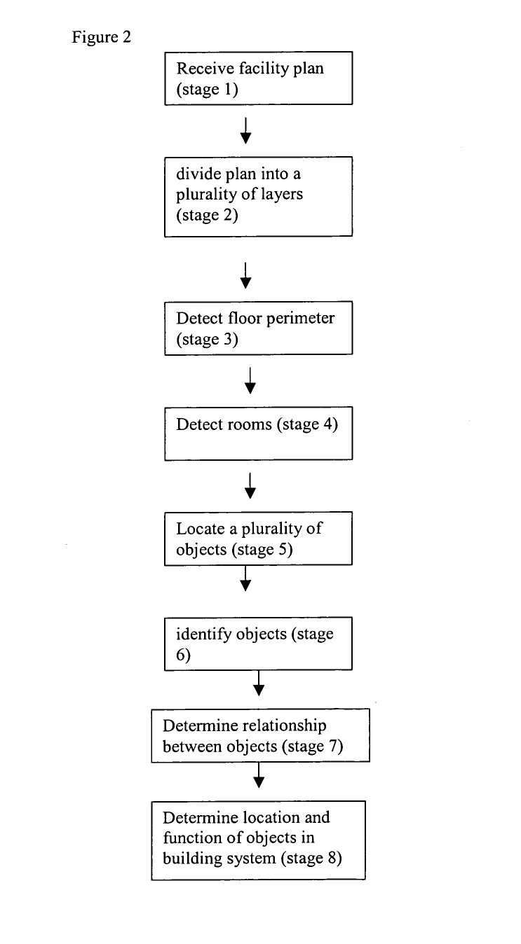

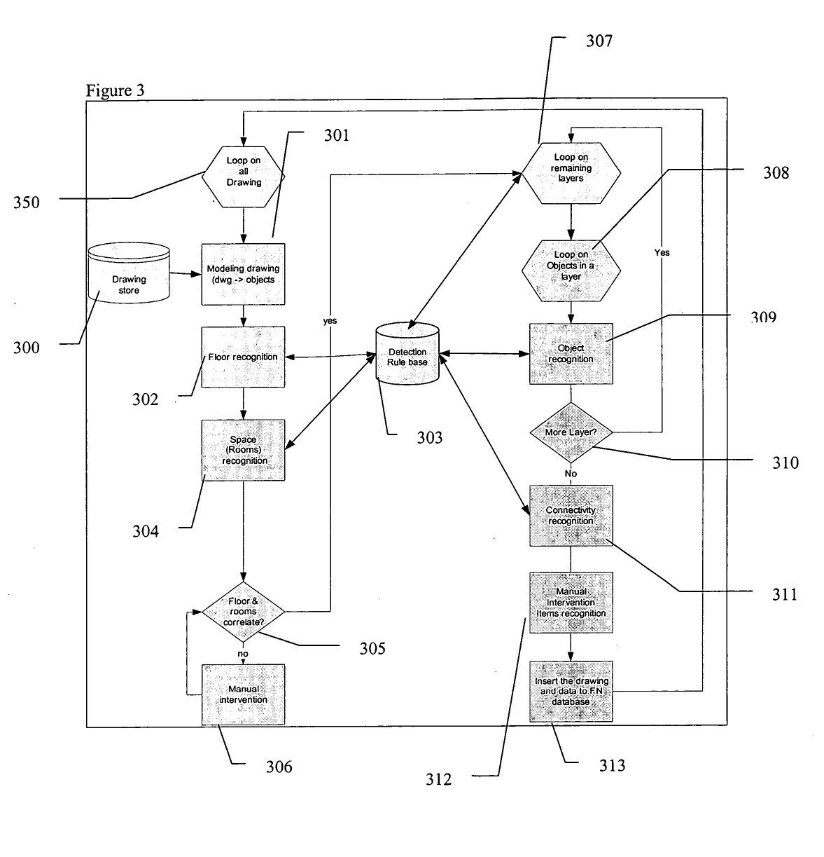

FIG. 1A shows a system 100 according to the present invention. An ADR engine 120 receives a facility plan from an external drawing store 150 and analyzes it, in order to discover the various objects included in the facility plan as well as the relationships between these objects. The analysis is preferably performed according to a plurality of rules from an ADR rule base 152 (see FIGS. 2 and 3 for a more detailed description of the analysis method).

The relationship between these objects enables ADR engine 120 to determine the structure of the various building systems, as well as the location of various objects in these systems. This information is then passed to a navigator system 102 for providing information about the building systems. Navigator system 102 is preferably in communication with a drawing data store 106. Drawing data store 106 features a model of the facility, including plans for at least one and preferably a plurality of facility systems. This model is based upon information determined through automated analysis of a facility plan by ADR engine 120. Database 104 preferably stores other types of data about the facility model, such as a description of various connections between objects for example, and optionally also including object names and other information about the objects.

Database 104 and drawing data store 106 preferably communicate with a frame works module 154 through a database interface 156. Frame works module 154 is described in greater detail with regard to FIG. 1B; briefly, this module enables the information in database 104 and drawing data store 106 to be provided to a user interface (not shown; see FIG. 1B). Frame works module 154 is described herein according to a logic diagram, such that the components may optionally be distributed throughout a plurality of servers and/or other locations for implementation; furthermore, frame works module 154 is preferably implemented as an intermediate logic level for providing access to applications and functionality according to the present invention as described in more detail with regard to FIG. 1B.

Navigator system 102 also preferably communicates through an interface 158 for supporting interactions with a maintenance system 112, a drawing and file management system 114 and a building automation and control system 116. It should be noted that interface 158 may optionally be implemented as any type of network or computer interface, although communication through web services is a preferred embodiment of the present invention.

Maintenance system 112 preferably provides information concerning routine maintenance actions that are required and/or whether certain repair actions are required. Drawing and file management system 114 preferably enables the user to see retrieve one or more drawings (regarding facility plans) to see whether they have changed.

Building automation and control system 116 preferably provides the state of each facility system, thereby enabling the user to see the state of each such system, including whether any problems or faults have occurred.

It should be noted that optionally and preferably, maintenance system 112, drawing and file management system 114 and building automation and control system 116 are implemented according to systems that are known in the art, such as the Facility Navigator™ of Columbus Application Provider Ltd (Israel) for example. One of ordinary skill in the art could easily implement these systems.

Navigator system 102 is optionally and preferably in communication with a security interface 160, which in turn preferably communicates with an external management control module 162. Optionally any suitable communication protocol may be used, although preferably a secure protocol (such as HTTPS for example) is used. Furthermore, optionally and preferably any type of external management control module 162 may be used, such as ActiveDirectory™ (Microsoft, USA) for example. Security interface 160 preferably allows a human administrator to control access to the data of system 100, for example by determining one or more permissions for one or more users, through an existing authentication and authorization system, rather than requiring a special authentication and authorization module or protocol for system 100.

FIG. 1B shows portions of FIG. 1A in more detail. As shown, frame works module 154 is in communication with a plurality of user interface modules, shown collectively as user interface 170 (which may optionally also be described as a client). User interface 170 may optionally include any type of computational device as previously described. User interface 170 may optionally be connected to frame works module 154 through any type of communication network, including without limitation a LAN (local area network), a WAN (wide area network), or the Internet. User interface 170 may optionally be a web-enabled client that communicates with frame works module 154 according to HTTP (hyper text transfer protocol) although any suitable communication protocol may optionally be used.

User interface 170 enables the user to manage at least one facility system, optionally including analyzing relevant system data to determine when maintenance is to be performed on the facility system. Furthermore, as described in greater detail below, user interface 170 also enables the user to receive information about one or more faults in one or more facility systems that must be repaired, and/or information about one or more parts of the facility (such as one or more rooms for example) that are affected by such one or more faults in one or more facility systems. Unlike notification systems that are known in the art, the present invention is preferably able to analyze these one or more faults to determine the root cause, as described in greater detail below.

According to preferred embodiments of the present invention, user interface 170 optionally and preferably comprises a reporter interface 172 for providing information, preferably through a Web communication protocol, such as through HTTP for example. Reporter interface 172 may optionally, additionally or alternatively, communicate through e-mail, SMS or any other suitable messaging protocol which could easily be determined by one of ordinary skill in the art. Reporter interface 172 preferably provides information in the form of a report to the user, for example regarding one or more faults detected, one or more analyses showing the cause of the one or more faults (and/or the effect of the one or more faults on a part of the facility, such as a room for example) and/or one or more maintenance actions that are required. Other types of reports may also optionally (additionally or alternatively) may be provided, for example for commissioning, bill of materials or disaster recovery, as described in greater detail below.

Reporter interface 172 preferably communicates with a report generator 174 of frame works module 154. Report generator 174 preferably generates the one or more reports to be provided to the user regarding the above subjects, by assembling information through database interface 156 according to one or more user queries. Optionally and preferably, one or more templates are provided to assist the user in selecting information (and preferably the desired format) for the report. For example (and without intending to be limiting in any way), a simple template may optionally feature a table of detected faults with the analyzed root cause provided. As another non-limiting example, a more complex template may optionally feature a more detailed description of each fault and the analyzed root cause(s), together with a diagram showing the facility plan and the location of the fault and the root cause(s) on the facility plan.

Report generator 174 is preferably adapted to the communication protocol of reporter interface 172, such that report generator 174 supports reporter interface 172 for communication through a network such as the Internet for example. As a non-limiting illustrative example, if reporter interface 172 features e-mail, then report generator 174 is optionally and preferably an e-mail server such as an SMTP server for example.

According to optional but preferred embodiments of the present invention, frame works module 154 preferably comprises a notification server 176. Notification server 176 preferably obtains data from database 104 and/or drawing data store 106 through database interface 156 as previously described. Notification server 176 then preferably analyzes such data to determine when an alert or alarm message needs to be sent to the user through a real time server 108.

Real time server 108 may optionally, additionally or alternatively, provide one or more alerts or alarms to a user, for example through e-mail, SMS, being paged on a beeper or any other suitable messaging protocol which could easily be determined by one of ordinary skill in the art.

Real time server 108 is preferably adapted for communication to the user according to a desired protocol, for example for communication through a network such as the Internet for example. Such communication is optionally provided in the form of one or more alarms or alerts, for example optionally through an alarm interface 175 as shown. As a non-limiting illustrative example, if alarm interface 175 features e-mail, then real time server 108 is optionally and preferably an e-mail server such as an SMTP server for example. According to preferred embodiments of the present invention, optionally and preferably the user is able to select one or more communication methods, such as for example the above described methods of SMS, e-mail, being paged on a beeper and so forth. More preferably the user is able to specify different methods according to different conditions, such as time of day and/or physical location. For example, preferably the user is able to indicate that an alarm or alert is to be sent by e-mail during normal working hours but by SMS after normal working hours.

Alternatively or additionally, other types of communication methods and/or protocols may optionally be supported. According to preferred embodiments of the present invention, user interface 170 preferably features a screen interface 178 for displaying information to a user through a GUI (graphical user interface). Screen interface 178 receives data and information from frame works 154 through GUI interface 180, which preferably formats the information for display to the user. GUI interface 180 preferably communicates with real time server 108 as shown in order to receive one or more analyses of the data, as described in greater detail below.

GUI interface 180 also preferably supports one or more queries by the user regarding data and/or objects in the facility plan. These queries are preferably given to real time server 108. Real time server 108 receives on-line data from database 104 and drawing data store 106 through database interface 156, and then analyzes this data as described in greater detail below. It should be noted that database 104, drawing data store 106 and database interface 156 may optionally be collectively described as a data layer.

For example, real time server 108 preferably provides information concerning the state of each facility system, thereby enabling the user to see the state of each such system, including whether any problems or faults have occurred. As previously described, the raw data regarding any current or past problems is preferably obtained from building automation and control system 116, and is then analyzed according to information obtained from ADR engine 120 (not shown; see FIG. 1A for both components) by real time server 108. Real time server 108 itself (without reference to ADR engine 120) may optionally be implemented as is known in the art, for example according to the Facility Navigator™ (Columbus Application Provider Ltd, Israel). However, the combination of real time server 108 and ADR engine 120 is a novel, optional but preferred embodiment of the present invention.

Real time server 108 also preferably enables the user to see the location of one or more objects in each facility system, optionally and preferably displayed in the form of a CAD/CAM drawing and/or other suitable drawing format. More preferably, the user is able to select an object in the drawing and click on it to receive more information. This information is preferably provided according to drawing(s) obtained from drawing and file management system 114, analyzed according to ADR engine 120 and then more preferably provided to the user in the form of a “clickable” drawing format, such that the use of a GUI (graphical user interface) preferably permits the user to view various objects on the screen which correspond to one or more objects in one or more facility systems according to their physical or logical location, then to select one or more such objects to receive more information. Such a GUI may optionally and preferably be provided through screen interface 178 as described previously.

Real time server 108 also preferably enables the user to see the security state of the facility, including the state of the automation and control system and also whether one or more facility systems have suffered a security breach, preferably by communicating with building automation and control system 116. Building automation and control system 116 optionally connects to any number of security devices via the Internet or any communication network supporting TCP/IP protocol. Real time server 108 optionally and preferably has analysis capabilities including the ability to activate devices through building automation and control system 116 and/or to send alarms. Optionally and more preferably, building automation and control system 116 enables video display from one or more cameras to be provided to user interface 170, and more preferably to screen interface 178 through Frame Works 154, optionally and most preferably according to HTTP or any other suitable protocol for operation with a interface as shown, according to instructions received from real time server 108. Optionally and preferably, the user could select current view of any single camera or group of cameras, and/or could select viewing according to a previous time period.

Real time server 108 may optionally instruct building automation and control system 116 according to facility plans (such as information received from drawing and file management system 114), to display any camera current view and show camera location on the CAD drawing as part of floor or building layout for the user. The user can also optionally and preferably select the camera by clicking the location on the drawing without the need to know camera ID or name. The user can preferably switch between cameras, and can control zoom and pan if the camera's driver supports it, through communication with real time server 108.

The combination of navigator system 102, maintenance system 112, drawing and file management system 114 and building automation and control system 116 with real time server 108 (and optionally other components of Frame Works 154) may optionally be termed a system management module.

For administration purposes, optionally and preferably a system administrator can access frame works 154 through a sys admin display 182, which is preferably supported by a UI generator 184 of frame works 154. UI generator 184 preferably allows the system administrator to manage the system. Although user permissions may also optionally be changed through UI generator 184, as noted previously, preferably such security control is provided through an existing authentication and authorization system as described with regard to FIG. 1A.

FIG. 2 shows a flowchart of an exemplary method according to the present invention for automatically analyzing a facility plan. As shown, in stage 1, a facility plan is received in an electronic drawing format. In stage 2, the plan is divided into a plurality of layers. The layers are present in the facility plan and are preferably detected according to the software format of the plan. Exemplary but non limiting formats include the OpenDWG format, DWGdirect (based on OpenDWG), and other DWG based formats (see for example www.opendesign.com/downloads/spec/ch00a.htm for a description of the OpernDWG format). The DWG format was originally developed by AutoDesk (USA) for the AutoCAD software and is a binary drawing format. Other suitable formats include OpenDGN, related to the DGN format of Bentley Systems. Any other suitable drawing format may optionally be used, although the present invention is described with regard to the OpenDWG format; furthermore, many different types of converters are available for converting between various file formats for facility plans, such that one of ordinary skill in the art could easily convert to the OpenDWG format from any other type of suitable format.

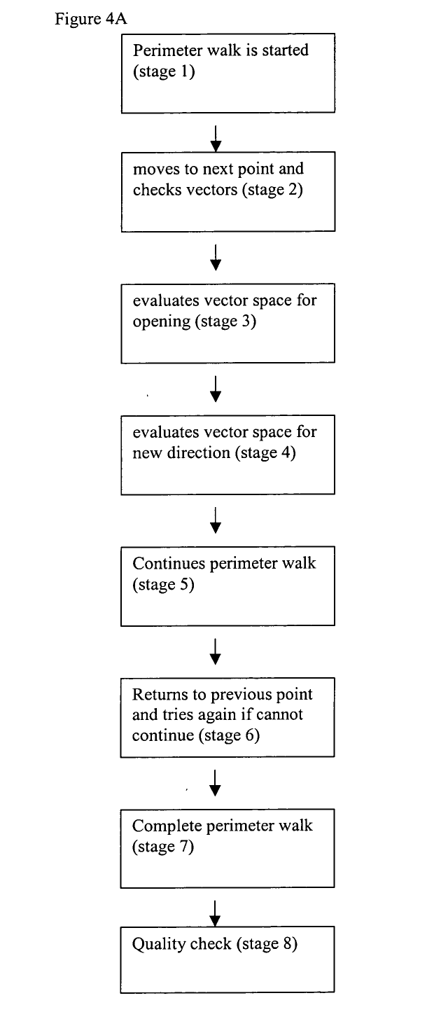

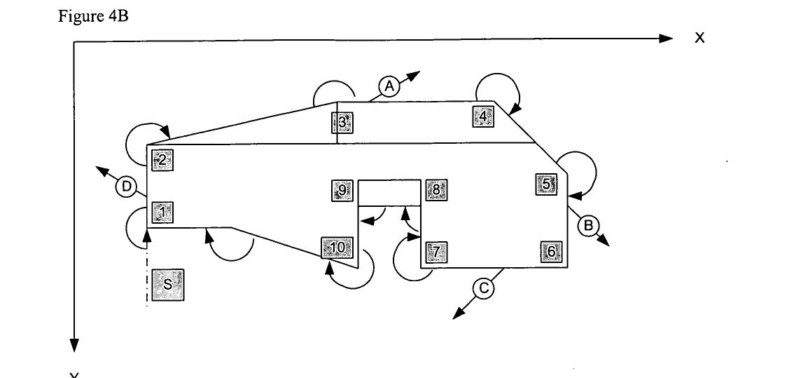

In stage 3, each layer is analyzed to detect the floor perimeter. A more detailed description of an exemplary floor perimeter detection method is provided with regard to FIG. 4, but preferably a perimeter walk is performed to detect the boundaries of the perimeter.

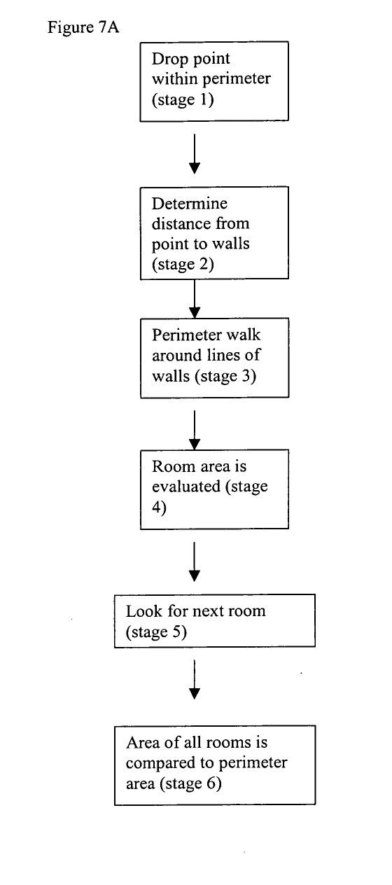

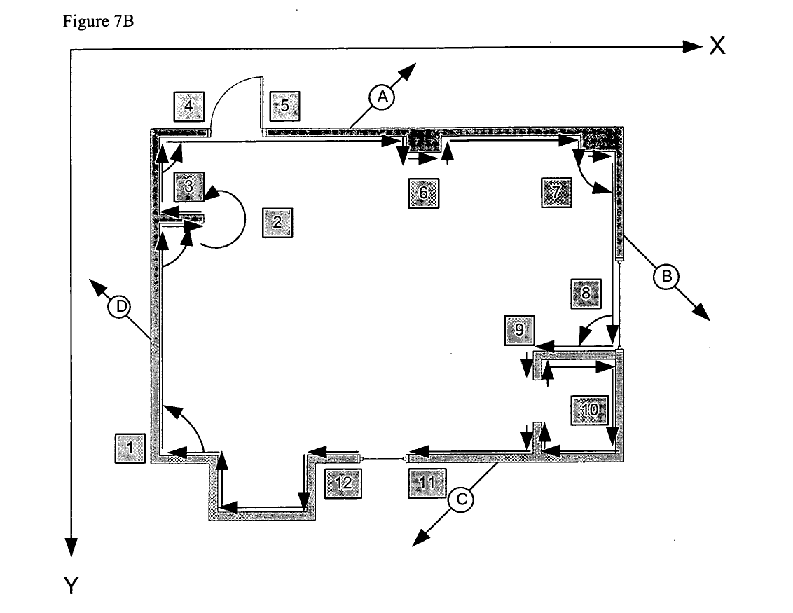

In stage 4, the rooms within the floor are detected. Preferably each room is detected by dropping a point into the space of the floor and determining the distance to the lines closest to this point. If they fit within certain distance parameters then the space may be designated as a room. An exemplary method for detecting rooms is described with regard to FIG. 7.

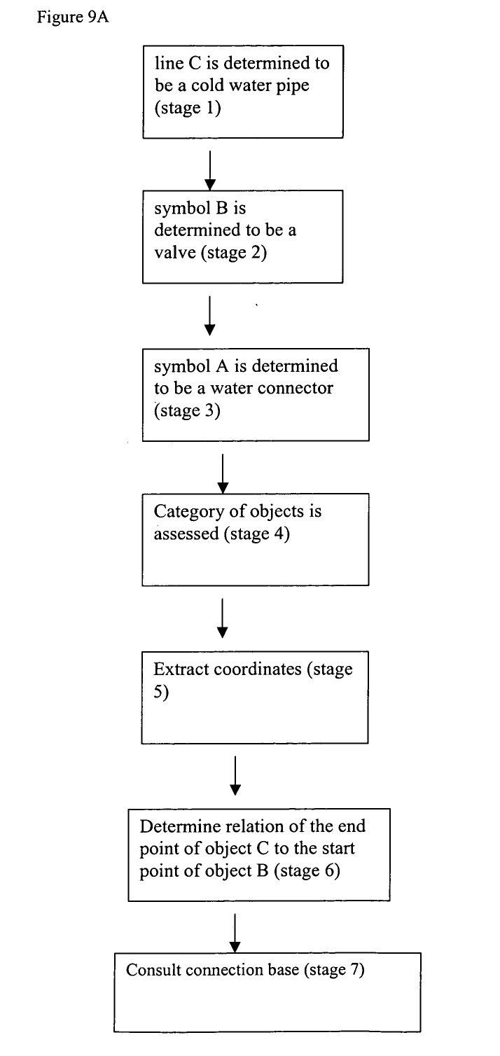

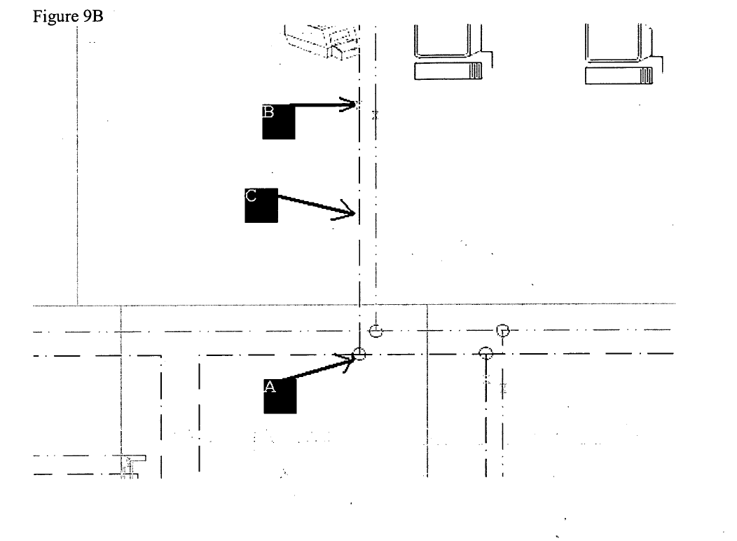

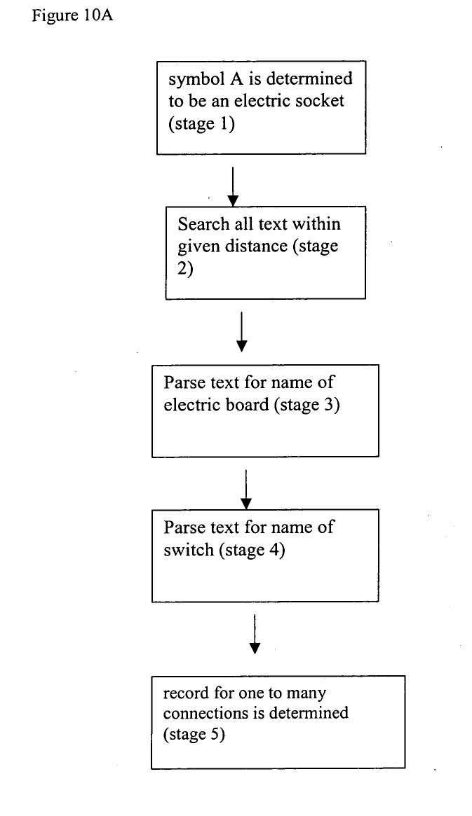

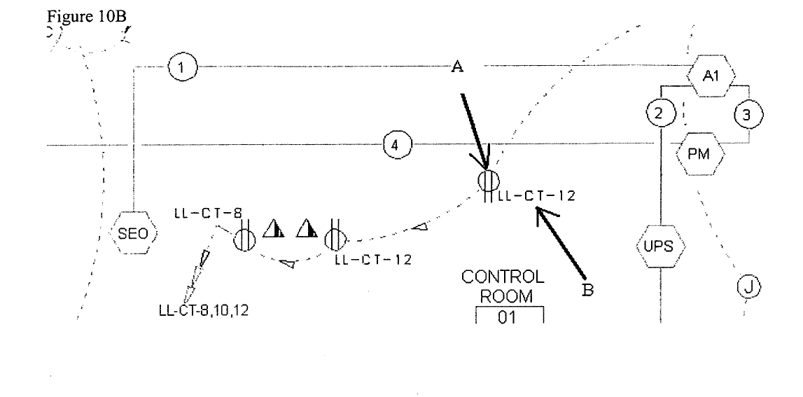

In stage 5, a plurality of objects are located on the floor in relation to the rooms. In stage 6, the objects are identified, preferably including an identification as to which type of building system they belong. In stage 7, a relationship between the plurality of objects is determined. In stage 8, the relationship is used to determine the location and function of objects in the building system. These stages are described in greater detail with regard to FIGS. 9 and 10.

FIG. 3 shows an exemplary process for handling a number of drawings according to the method of FIG. 2 in more detail. Process 350 loops on all drawings that need to be identified and extracts them from the drawing store 300 to stage 301. Stage 301 is the process of reading the drawing file and converting it to object structured data. This conversion may optionally be done by third party software (as described for example in www.opendesign.com). For example, the DConvert utility described at that web site converts between the DWG and DXF formats (the latter is the native vector format for the DWG format, and is another exemplary but non-limiting, illustrative type of drawing format that may optionally be used with the present invention). Various types of software programs are available for such conversions and/or could easily be implemented by one of ordinary skill in the art.

Optionally and preferably, the drawing is read and the data within the drawing file is preferably loaded into an object model. The object model enables the system to retrieve the drawing data in many ways, for example by layer. The object model is preferred for the operation of the method of the present invention because the objects in the drawing itself are not given in a hierarchical manner; by loading the objects into the object model, a hierarchical representation of the objects is obtained which can then be analyzed.

With regard to the OpenDWG format (as a non-limiting illustrative example), the objects for the object model may optionally be read from the file itself, in a section of the file devoted to these objects. Information provided may optionally include the object's size, type, handle and a flag if the object is actually a graphic entity. If it is a graphic entity, then it has an associated graphic image. This format also includes an object table, which lists the location of each object in the file. Information about the objects also preferably includes the location of an object in a particular layer, which as noted previously may optionally provide information about the function or type of an object, since once a particular object has been identified in a particular layer, other objects found in that layer may have the same or similar function or type identification.

Next, a floor recognition stage 302 is performed, in which at least one floor of a facility is determined from the facility plan, preferably according to one or more rules in a detection rule base 303, as described in greater detail with regard to FIG. 4.

Each floor is then preferably analyzed in a space division recognition stage 304, in which one or more rooms are preferably identified within the facility plan. This stage enables the skeletal outline of the space to be determined, including determining the boundaries of each room. Preferably, this stage is performed by analyzing lines within each plan to determine the location of at least one polygon. The boundaries of each polygon are then preferably analyzed to determine that no polygons overlap and also to determine that no plurality of polygons can be collapsed to form a single larger polygon. This analysis is preferably performed according to a plurality of rules in detection rule base 303.

In stage 305, the space occupied by the rooms and the overall space of the floor are compared, to be certain that the correlate. If they do not correlate, for example if the total area occupied by all rooms together is greater than that of the floor itself, then manual intervention by the user is required in stage 306. The user may optionally ask to see the result of stages 302 and 304 in order to make minor changes to the room and floor recognition results.

If the space occupied by the rooms and the overall space of the floor do correlate, then in stage 307, a process is started in which optionally and preferably each layer of the plan for the floor is examined. Preferably, the facility plans are provided as electronic formatted drawings of a known format (such as the DWG format of AutoDesk or the OpenDWG format described previously), in which each facility system (such as electricity, plumbing, HVAC etc) is represented as a separate layer within the overall drawing. These layers can be distinguished within the electronic drawing according to the drawing format, which can easily be determined by one of ordinary skill in the art. However, it is not required for the operation of the method of the present invention.

In stage 308, a process is started in which optionally and preferably each object in the selected layer of the plan for the floor is examined from the previously obtained object model. Each object is preferably considered for analysis in a stage 309, which preferably also uses at least one rule from detection rule base 303. Stage 309 optionally and preferably features at least two phases, a first phase in which each object is recognized, and a second phase in which all available data about the object is extracted. It should be noted that although this description centers around the term “object”, it will also be operative for analyses of symbols on drawing plans.

In the first phase, each object in the drawing is compared to a rule in detection rule base 303. If the object in the drawing exactly matches an object as defined by a rule, then the process ends and the object in the drawing is considered to be identified. For example, three parallel lines may be identified as an electrical switch.

If no exact match is found, then optionally and preferably various deformations of the object are considered, as defined by one or more deformation rules in detection rule base 303. These deformations may optionally be determined according to required statistical accuracy and/or one or more heuristics (for example concerning frequent variations of such objects) and/or one or more deformed objects as present in detection rule base 303. The latter may have been determined through one or more earlier analyses of the same or different floor plans and/or facility plans; once included, they may optionally be treated as any other object in detection rule base 303.

A location of the object within a floor plan may also optionally be used to identify the object. For example, a light is not an object which is expected to be embedded in a wall. The location is preferably used to at least select an object identification from a plurality of such identities. More preferably, even if the object is clearly identified, preferably the location on the floor plan is used as a check to be certain that a correct identification was made. If the location is not logical, according to at least one rule in detection rule database 303, then preferably the user is alerted and/or the object returns to the start of the analysis process for further processing.

Optionally, if more than one “probable” match is found, the user may be asked to select between the different choices for the match. The selection may also optionally be added to detection rule base 303 for future analyses.

Optionally and preferably, if a first object cannot be identified, then the process continues until a second object is identified, preferably having a spatial relationship to the first object. This spatial relationship may optionally be used to identify the first object. For example, a light needs to be connected to a light switch, so if one of these objects is identified, followed by the identification of a connection to an unknown object, the connection itself may enable the unknown object to be identified.

Also optionally and preferably, if an object cannot be clearly identified but text next to the object can be identified in the second phase of data extraction, then the text may optionally be used to identify the object.

In the second phase, all data available about the object is preferably extracted. This information may optionally be embedded in the electronic drawing itself as provided through the object model and/or may be determined according to text associated with each object. First, the correct text needs to be identified. Such an identification is preferably performed according to a combination of location (i.e. spatial nearness to the object in the drawing) and content of the text (i.e. the use of one or more symbols or text strings that are typically associated with a particular type of object).

Next, the text is preferably extracted and analyzed, for example to determine the subtype of the object, as well as to provide specific information about the object. For example, for an electrical switch, the text could optionally specify the make and model.

Next, the combination of the text and the object identification is preferably reviewed to make certain that the object has been correctly identified, according to at least one rule in detection rule database 303.

Optionally, additional information may be provided for object identification, such as the color of the object; typically (although not necessarily) all objects of a single type, such as a security light for example, may be given the same color in the electronic drawing format. If the object has a particular color that is shared with other objects of a certain type, then preferably the object is compared to these other objects to see whether it can be identified as belonging to the object type.

According to preferred embodiments of the present invention, once the user introduces a new rule to detection rule database 303, the process may optionally return to the beginning and redo or at least review the previous analyses according to the new rule. Such a review or redoing of the analysis may optionally be performed manually, optionally for those object identifications selected by the user, or alternatively may be performed automatically.

In stage 310, the process preferably considers whether the facility plan has a layer that has not yet been analyzed; if so, then the process preferably returns to stage 307. Otherwise, the process preferably continues to a connectivity recognition stage 311. Optionally, connectivity recognition may be performed per layer (not shown).

In connectivity recognition stage 311, the spatial and logical connections between the objects are preferably determined. The spatial relationships are preferably determined according to at least one rule in detection rule database 303, optionally featuring at least one modifier, so that if the distance is not exact but is instead within a range defined by a combination of the rule and the modifier, it is accepted. The rule and the modifier are preferably at least partially dependent upon the pairs of objects being considered, such that a permitted distance between a light and an electrical switch may optionally differ than that between an air-conditioning unit and an electrical line. If the spatial distance between two objects does not conform to the rule (or the rule plus optional modifier, which determines how much flexibility is to be given when applying the rule), then optionally the user is informed and asked to determine the correct identity of the objects. Alternatively and preferably, the objects in question are again subjected to the object identification process with the spatial information included.

One object may optionally be located within another object, as for example a duct could overlap an air-conditioning unit to show that the duct continues past the unit.

Spatial relationships are preferably built up into spatial relationships between other groups of objects, by connecting such pairs (and preferably triplets, quadruplets etc) until no more connections are available.

The logical connections are those which are required according to the functionality of the particular objects. For example, an electrical switch needs to be logically connected to an electrical cabinet. This could happen by detecting the label associated with the switch and then examining the labels on the electrical cabinet; each switch label has a corresponding electrical cabinet label. The two labels may be matched according to the text.

Optionally and preferably, the connections are examined after all objects have been connected within a system, to make certain that they fulfill certain logical conditions. For example, an electrical connection to a light must ultimately lead to a connection to an electrical cabinet, a plumbing pipe cannot abruptly begin or end in the middle of a floor without any further connection to any other object, a light cannot be located within a wall, a single pipe cannot be designated as carrying both gas and water, and so forth, preferably according to rules in detection rule database 303.

Next, the process preferably connects objects between systems, following similar rules as above. The object connections between systems are preferably done in a hierarchical manner according to the object model provided previously, such that optionally and preferably the connections are made in the order determined by the hierarchy of the object model.

In stage 312, the user is optionally presented with the opportunity to manually review the automatically analyzed plans, and to make any necessary changes. If any changes are made, the entire process may optionally repeated, or only a part thereof as specified by the user.

In stage 313, the analyzed drawing and the data are inserted into the database(s) of FIG. 1.

FIG. 4 shows an exemplary method for floor perimeter detection according to the present invention. The method preferably involves walking around the perimeter clockwise. The method is described with regard to FIG. 4A, while certain aspects are described in more detail with regard to an exemplary floor perimeter plan in FIG. 4B.

In stage 1, the method starts the walk from a point in the perimeter, which may optionally be any random point. In stage 2, the method moves to the next point, where it evaluates a plurality of vectors, optionally according to a matrix, although alternatively any method for evaluating the vectors may optionally be used, as described for example with regard to FIG. 4B. The method preferentially selects a vector which continues in the same direction as the last vector. If such a vector is not available, then in stage 3, the method evaluates the vector space to see whether another point is available within a given distance. This distance is preferably determined according the rules database described with regard to FIG. 3, and indicates whether an opening may have been detected. For example, without wishing to be limited, the opening may be expected to be between 1 to 2 meters. Openings of different sizes may also optionally be provided, for example manually (through querying the user) or automatically (for example by analyzing a plurality of drawings for a particular facility). Such a distance may optionally be determined statistically for the particular drawing and/or for the particular facility (which may feature a plurality of drawings) and/or for any collection of a plurality of drawings. If the point is available, then the method returns to stage 2 and continues.

If no such point is available, then the method again preferably evaluates the vector space to determine where the perimeter may continue in stage 4 in a new direction. The method preferably evaluates the vector space in a box of four vectors which allow the entire vector space around the point to be sampled. Although optionally any order may be used, the method preferably first starts with a vector that points up and to the right, and then continues in clockwise fashion around the four vectors. Once a suitable point for continuation has been detected, then in stage 5 the method continues the perimeter walk. If the method is unable to find a continuation point, then in stage 6 it returns to a previous point and tries to continue again in another direction from the previous point.

In stage 7, the perimeter walk is complete. In stage 8, preferably at least one quality check for the perimeter is performed. For example, the area delineated by the perimeter may optionally and preferably be determined, to see whether it is clearly too small (for example two inches square) or too large (several miles square). Preferably, the method incorporates information from previous floors to check the perimeter, such that the floor perimeters should have some relationship in terms of size and shape (although typically this is not exact). An advantage of the method according to the present invention is that it does not rely on any presupposed angles or floorplans in order to detect the floor perimeter.

FIG. 4B describes the method of FIG. 4A with regard to an exemplary, illustrative perimeter floor plan. As shown, the perimeter walk may optionally start at point “S”, which is outside the floor itself. The plan is analyzed until point 1 is reached, which is the first point reached on that vector. At point 1, a decision is made as to whether to go in the direction of point 2 or in the direction of point 10. The method optionally and preferably decides to go in the direction of point 2 because the angle between this vector and vector D is smaller than the angle to vector in the direction of point 10. The method continues until point 2 is reached according to the vector labeled “D”. The arrow describing a partial circle shows one illustrative method for searching through the vector space for the next vector to be selected; as the perimeter walk is optionally and preferably performed in a clockwise direction, so is the vector search optionally and preferably performed in a clockwise direction through vector space at the point at which the current vector is no longer viable.

At point “3” there is a change in vector, as the only vector that fits the rules for the method is vector “A”. As before, the method preferentially continues in the same direction (i.e. according to the same vector) until that vector is no longer viable (i.e. the perimeter ends and does not continue along that vector). In this example, at point “4” there is a change in direction but not a change in vector. The method again preferentially continues in the direction of the new vector until point “5”, at which there is another change in vector to vector “B”. At point “6”, the vector changes again to vector “C”. Four more turns around the corners of the perimeter are required at points 7-10, in which the method correctly determines that the perimeter shifts direction four times to describe an upside-down “U” shape, rather than connecting points 7 and 10 directly, which would be incorrect. Points 7 and 10 are preferably not connected directly because the distance between them is larger than a maximum permitted distance for an opening. Points 7-8 follow vector “D”; points 8-9 follow vector “C” (in the “minus” direction) and points 9-10 follow vector “B”.

From point 10 to the start point (point 1), there is another turn although not another vector change. Once the method returns to the start point, then the perimeter walk is finished and the perimeter has been discovered.

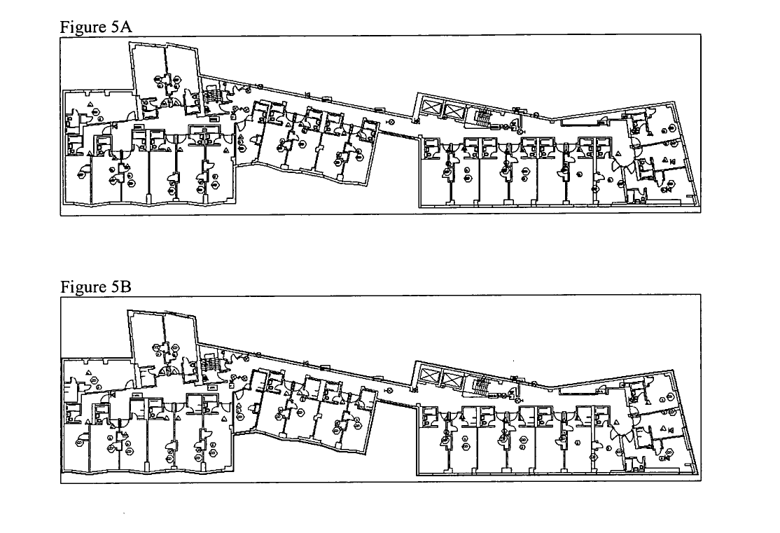

FIGS. 5A and 5B are “before” (FIG. 5A) and “after” (FIG. 5B) illustrations of exemplary non-limiting building plans. As shown in FIG. 5A, one floor of a complex facility plan is provided. The perimeter is not a simple square or rectangle, but rather features many odd angles and corners in an irregular shape. FIG. 5B shows the same floor plan after the operation of the method of FIG. 4; the darker black line shows that the method successfully traced the entire perimeter of the floor by “walking” the perimeter as described with regard to FIG. 4.

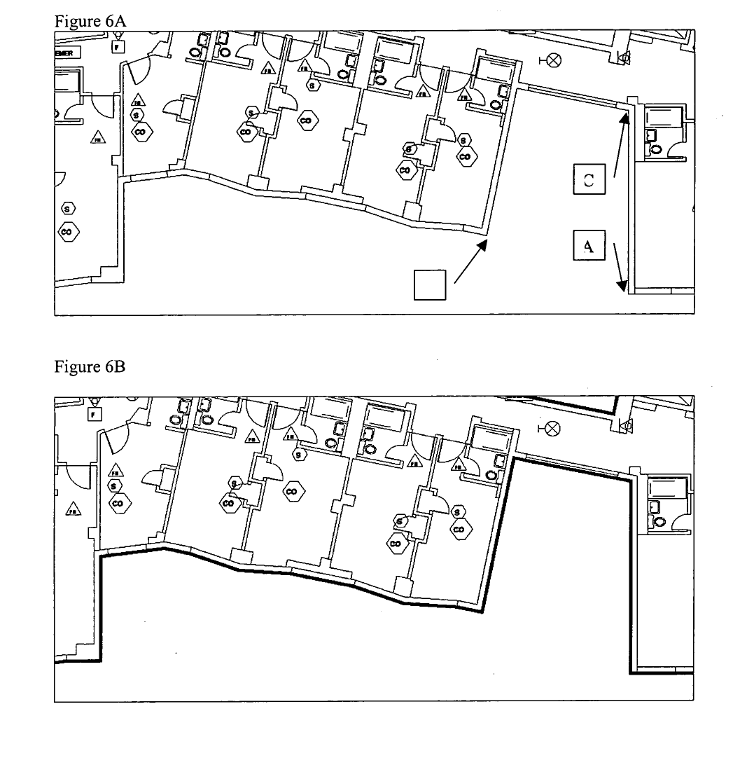

FIG. 6 shows some of the more difficult aspects of the floor plan of FIG. 5 in more detail, in order to explain one preferred embodiment for how the method of the present invention overcame these difficulties. FIG. 6A shows a problematic aspect of the floor plan of FIG. 5 in more detail, with three points labeled, A, B and C. When reaching point A, the method has two options to continue: it can either decide that the gap between point A and point B is an opening or entrance to the floor and connect points A and B; or alternatively it can continue to point C and “walk” around the external perimeter wall until reaching point B. The correct choice is clearly to continue to point C, and not to connect points A and B. The method is preferably able to make this correct choice as described previously, and the perimeter walk continues as shown with regard to FIG. 6B. Again, these difficult aspects illustrate advantages of the method according to the present invention, which is not restricted to any type of template or model but instead can operate freely with the floor perimeter as provided in the electronic drawing.

FIG. 7 shows an exemplary method for room detection according to the present invention, for example for detecting the rooms of the exemplary floor plan shown in FIG. 5. FIG. 7A shows the method itself, while FIG. 7B relates to an illustrative example for using the method for detecting a room perimeter of an exemplary non-limiting room.

As shown in FIG. 7A, in stage one, a point is dropped randomly within the perimeter. In stage two, the distance from the point to lines that indicate walls are determined, preferably according to a variation of the perimeter walk algorithm. More preferably, the perimeter walk algorithm is varied to “walk” around the interior of the room rather than the exterior of the room. In stage three, a perimeter walk around these lines is performed, as for the floor algorithm described in FIG. 5. In stage four, the area of the room is evaluated; if it is too small, then the “room” parameters are not saved. If it is within certain range of sizes then it is saved as a room. Without wishing to be limited, the room may be expected to have a size in a certain range, depending upon the function of the building or facility and of the room itself, as for example an indoor stadium will have differently sized rooms than an office building. The minimum room size is optionally about 8 square feet, although of course that depends upon the type of building or facility and uses for the rooms (and may optionally also depend upon local planning rules and regulations for the area). In stage five, the method preferably searches within a particular distance of the walls of the room for the next room, as each wall line is only used once in a facility floorplan. Optionally, the method starts on the left side of room and looks for the next wall within a particular distance, which may be the next room or which could be the wall of the perimeter.

In stage six, the area of all rooms is compared to the area of the floor perimeter as described in greater detail below.

FIG. 7B shows an exemplary, non-limiting room plan which is analyzed according to the method of FIG. 7A. As shown, the start of the room detection method is at point 1. The vector search (which may optionally be performed according to a matrix but is preferably performed according to the method of FIG. 4B) indicates that the room has a corner (vector D). The method follows the new vector until a partial wall is reached at point 2. This wall is not complete (i.e. does not represent the boundary of the room) and so the method continues around it. The incompleteness of the wall is determined by the fact that from the end of the partial wall to the start of the next wall there is an opening that is larger than the maximum permitted distance. Therefore, the method tries to find the continuation of the wall, which it does by turning a corner around the partial wall.

At point 3, the perimeter continues around a corner and past a door. The door may optionally be detected as an object and/or as an opening of a size that is less than or equal to a particular maximum size.

The method continues along vector A until point 4, at which point another partial wall which is not complete is found. The method continues with vector A until point 5, at which point the method switches to vector B. A window is detected at point 6, as an object and/or as an opening having a size that is within a maximum distance. At point 7, another partial wall is detected, after which the method returns to vector B. Points 8 and 9 show the method tracing another partial wall, detected as previously described. Point 10 shows the method tracing the interior portion of an open chamber, for which the opening preferably is not a door or other sealable closure in order for the open chamber to be included within the perimeter of the existing room (as opposed to being traced as a separately room). The perimeter trace then continues with vector C at point 11.

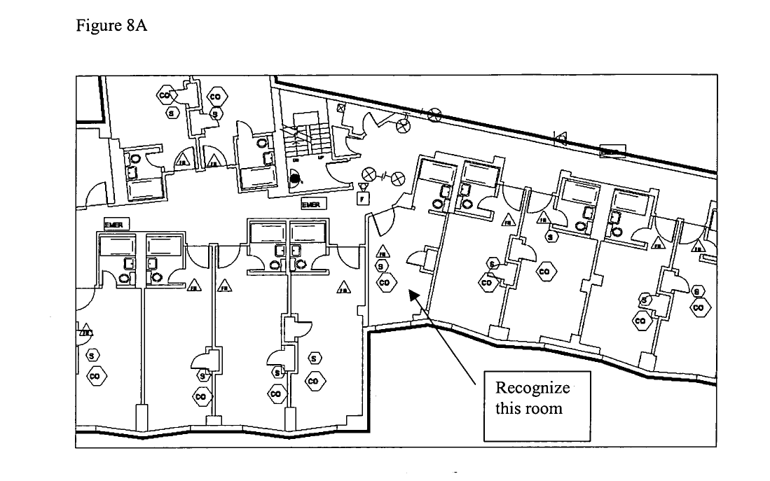

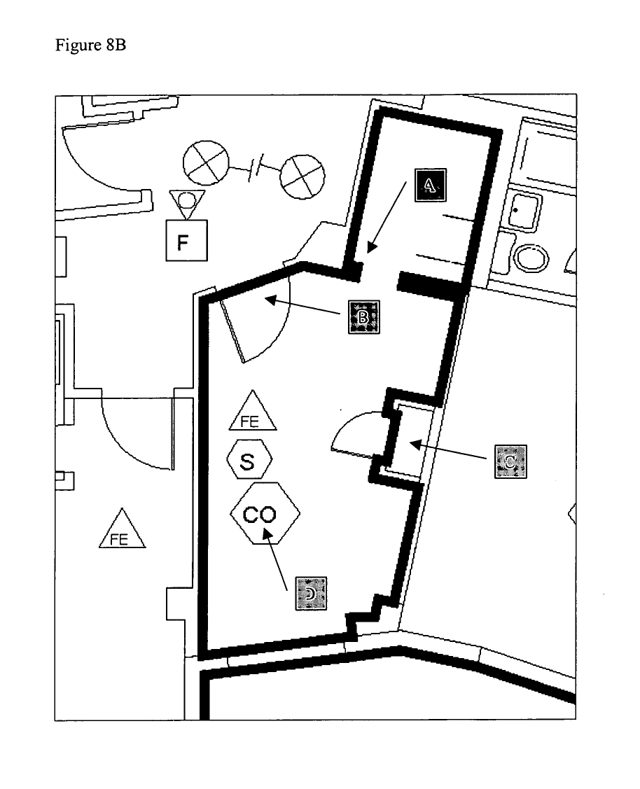

FIG. 8 shows some of the more difficult aspects of the floor plan of FIG. 5 in more detail with regard to room detection. FIG. 8A shows a detailed portion of the floor plan of FIG. 5, including a room having a complex shape. FIG. 8B shows how the complex room shape is detected. This room has an upper and lower portion and features a number of angles in its perimeter. As shown, the method of the present invention recognizes that the opening within the complex room is a continuation of the same room and adds the upper portion to the room, as shown with regard to point [A]. When an object that meets the criteria of a door is recognized the method skips over it, as shown with regard to point [B]. A door is optionally and preferably recognized as for any other object described previously, for example according to its shape and/or any other information provided in the electronic drawing. Alternatively or additionally, the door may optionally be recognized as an opening having a maximum size, as previously described.

An inner closet or compartment is not included in the room as shown with regard to point [C], as the method detects that the closet/compartment is completely closed off (it may optionally recognize the presence of a separate door object) and hence cannot form part of the room.

Preferably, additional items that exist in the drawing and do not match the criteria of a wall or door are ignored at this stage for room recognition, as shown with regard to point [D].

Once the rooms and floor perimeter have been detected, optionally the information may be combined for quality checks, preferably between floors. Within a floor, preferably the room area and the floor perimeter area match, after subtracting some area for wall space. Such an area for wall space may be estimated according to known building parameters, such as building code requirements, and/or may be entered by the user (for example, the walls of a “hardened” building may be thicker; this information can optionally and preferably be entered manually by the user). For a typical office building, wall space occupies from about 7% to about 10% of the total floor perimeter area.

Between floors, preferably such features as stairwells and elevator shafts are located at the same relative physical location. If they are not, then the method of the present invention preferably returns to the floor and room recognition processes for each floor in order to reevaluate the information. The user may also optionally be asked for information and/or to manually determine a floor perimeter (in part or in whole).

According to a preferred embodiment of the present invention, an atrium may be present. An atrium is a large open space, typically open from the ground floor to the roof. It is therefore typically present as a large open space on each floor of the floor plan after the ground floor. The initial room detection algorithm may detect it as a room; in order to determine that in fact it is an atrium, preferably the method of the present invention evaluates each floor against the other; if such a large open space is detected on a plurality of floors, it may optionally be indicated as an atrium. Optionally and preferably, other characteristics are used to detect the atrium, for example including a lack of objects or other features within the space of the atrium (there may optionally be lights or other objects on its perimeter). Alternatively, the user may be asked to identify the atrium as such.

FIG. 9A shows an exemplary method for determining the relationship between a plurality of objects according to the present invention for a water connection. As shown in stage 1, line C is determined to be a cold water pipe. Such a determination may optionally be made according to one or more of the layer template (which may optionally be identified as the layer for a water system (either pre-identified or else identified by finding another object in the layer that is associated with this particular system), so objects related to that system may be found in this layer template), line type (such as dotted, dash, unbroken and so forth), and/or line color. Any one or more of these attributes may optionally be used to identify the object.

In stage 2, symbol B is determined to be a valve. Such a determination may optionally be made according to one or more of the layer template, symbol name, and/or symbol shape. In stage 3, symbol A is determined to be a water connector. Such a determination may optionally be made according to one or more of the layer template, symbol name, and/or symbol shape. A plurality of objects is now available for determining the relationship between them, if any. In stage 4, preferably the category of these objects is assessed; if the objects belong to the same category, then the method proceeds. Otherwise, the method may optionally stop and/or the user may optionally be requested to consider the objects and/or the method may optionally proceed for more information.

In stage 5, by extracting coordinates from the drawing, the start point of object C is determined to be within object A. The coordinates (x,y) for the start and the end of objects C and A are known, so the start point of object C is determined to overlap the coordinates of object A. This may optionally be determined according to the object handle for the OpenDWG format (previously described). Optionally and preferably this distance is subjected to a parameter for tolerance such that if the distance is too far it is preferably rejected. If the distance is too near it may also optionally be rejected, although in some circumstances an object may overlap or be placed within another object as previously described.

In stage 6, the relation of the end point of object C to the start point of object B is determined.

In stage 7, the connection rule base is then preferably consulted, to determine whether objects A and B can be connected by object C. If so, then a record A-C-B is preferably created for the connection. If not, then the connection is consulted and a different set of relationships for these objects is considered. Optionally and preferably, this method repeats for pairs, triplets and so forth of objects, more preferably until the water facility system has been completely constructed.

FIG. 9B shows an exemplary water connection feature as for the method of FIG. 9A above.

FIG. 10A shows an exemplary method for determining the relationship between a plurality of objects according to the present invention for an electrical connection. As shown in stage 1, symbol A is determined to be an electric socket. This determination may optionally be made on the basis of one or more of the layer template, symbol name and/or symbol shape. In stage 2, all text on the drawing within a particular distance to symbol A is then searched; the distance is preferably defined as a parameter in the rule base. In stage 3, the rule base is consulted to determine which object(s) should be found, which in this example are a board name and main switch name.

In stage 3, when text is found (marked as B), it is parsed to determine whether it contains a name of an electric board. If it does, then the remaining of the string is parsed to determine whether it contains a name of main switch that belongs to that board, in stage 4.

If both parsing operations are correct, then a record for one to many connections for the object in relation with the main switch is determined in stage 5.

Optionally and preferably, this method is performed with pairs, triplets and so forth of objects until all objects in the electrical facility system and their relationships are determined.

FIG. 10B shows the electrical switch object in relation to the logical connections to the electrical board. The electrical board itself is not shown, but rather was found previously. For this non-limiting example, LL-CT is the name of electric board, while each switch features this name plus a number (such as LL-CT-12 in this non-limiting example, which is switch 12 of the board LL-CT).

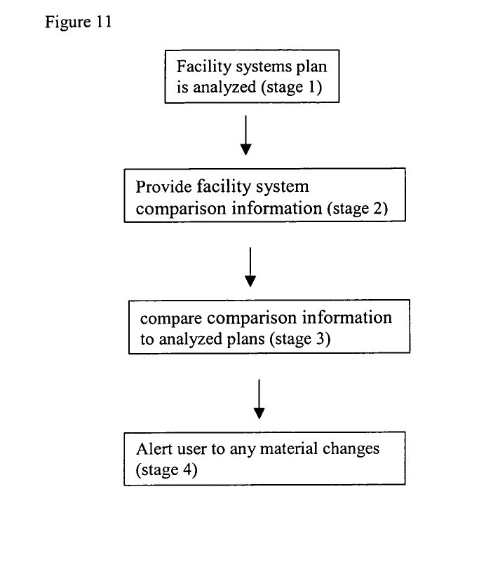

FIG. 11 shows an exemplary method for building commissioning according to the present invention. Building commissioning is a process for ensuring that the plurality of building systems are designed, installed and maintained according to the building system specifications (including the design and/or operating specifications). It may optionally be performed on any type of facility, including a group of buildings or other facility.

In stage 1, the facility systems plan is preferably analyzed as previously described. In stage 2, a plurality of facility system specifications is preferably provided. These specifications may optionally be provided as engineering standards information. Alternatively or additionally, if the actual facility systems were changed from the original design, then the original design may optionally be provided. Such changes may optionally be detected through regular field inspections while the facility is being built and also after the facility has been built. Additionally or alternatively, the information may optionally be provided as a rule base with a plurality of rules and requirements for describing the facility. Alone or together, this information may optionally be described as “facility system comparison information”.

In stage 3, the facility system comparison information is compared to the actual analyzed facility system plans. If any discrepancies are found, these are preferably flagged, for example through an alert to the user.

In stage 4, any material differences are preferably provided to the user for example by displaying the differences as messages and/or as graphic illustrations (for example optionally by showing the differences on a drawing that represents the facility plan or a portion thereof). For example, if a change to the specifications occurred between the original design for the HVAC system and the actual HVAC system, and this change has a negative impact on the standard or desired functionality of the HVAC system, the change is preferably indicated to the user.

Building commissioning may optionally be performed on facilities after they were built, even if no commissioning process was performed during the construction of the facility. For example, retrocommissioning is a systematic, documented process that identifies potential repairs and improvements to an existing facility, in order to support the design intentions of its current usage. As a facility is used, changes to the facility or to the systems in the facility may change the desired function of the facility from that which was originally designed. Continuous commissioning is similar to retrocommissioning and begins by identifying and fixing system problems in the facility, except that the process is preferably performed on a regular basis. These different types of commissioning are also optionally and preferably supported by the method of the present invention.

The method of the present invention may also optionally be used for disaster recovery, for example in order to assess damages and to determine which aspects of the function of the facility have been damaged or blocked, and/or optionally for daily maintenance.

According to other optional but preferred embodiments of the present invention, the method and/or system may optionally be used for determining a “bill of material”. As for commissioning, the method of the present invention is preferably used to automatically analyze the facility plan and to provide information about the objects and about one or more system(s) contained therein. Next, the analyzed information is used to determine a list of objects and their type, preferably including product specifications (such as a model or product category of door). This list is then preferably compared to a database of prices, in which the identifiers for products in the database match those of the product specifications. After the prices have been determined, a cost for the materials may optionally be calculated.

According to other preferred embodiments of the present invention, there is provided a method of performing design validation with the automated facility plan analysis method according to the present invention. The method preferably starts with an analysis of the facility plan as described above. Next, the analyzed facility plan and the resultant information from the analysis are preferably compared to a rule base featuring a plurality of rules for the design. The results of this comparison are then preferably provided to the user, for example optionally as a message or plurality of messages and/or optionally graphically, for example by displaying any differences on a drawing of the facility plan or a portion thereof.

Optionally, such design validation could be implemented in combination with CAD/CAM drawing software, such as AutoCAD software (AutoDesk USA) for example. Optionally such implementation could be provided as a “plug-in” to such software as is known in the art.

While the invention has been described with respect to a limited number of embodiments, it will be appreciated that many variations, modifications and other applications of the invention may be made.

What is claimed is:

1. A method for analyzing a facility plan, comprising:
receiving the facility plan as an electronic drawing;
identifying a plurality of objects in the facility plan to determine object identities; and
automatically determining a relationship between said plurality of objects according to said object identities.

2. The method of claim 1, wherein said identifying said plurality of objects is performed manually.

3. The method of claim 1, wherein said identifying said plurality of objects is performed automatically.

4. The method of claim 1, wherein said automatically determining said relationship is performed according to a category of each object, said object identity comprising said category.

5. The method of claim 4, wherein said category relates to a facility system.

6. The method of claim 1, wherein said identifying said objects comprising identifying text associated with each object and wherein said automatically determining said relationship comprises determining a relationship according to said text.

7. The method of claim 1, wherein said identifying said objects comprising identifying a spatial location of each object and wherein said automatically determining said relationship comprises determining a spatial relationship between said objects according to said spatial locations.

8. The method of claim 7, wherein said spatial relationship is determined according to a distance between said spatial locations.

9. The method of claim 1, wherein said automatically determining said relationship comprises determining a physical relationship between said plurality of objects.

10. The method of claim 1, wherein said automatically determining said relationship comprises determining a logical relationship between said plurality of objects.

11. The method of claim 1, further comprising:
automatically determining connectivity between said plurality of objects according to said relationship.

12. The method of claim 11, wherein said automatically determining said connectivity comprises identifying at least one facility system to which said plurality of objects belong.

13. The method of claim 12, wherein said automatically determining said connectivity comprises identifying a plurality of facility systems to which said plurality of objects belong and a connection between said plurality of facility systems.

14. A method for automatically analyzing a facility plan, comprising:
receiving the facility plan as an electronic drawing; and
automatically identifying a plurality of objects in the facility plan to determine object identities, wherein said automatically identifying said plurality of objects comprises at least one of automatically identifying an object category, text associated with each object, or a graphical element associated with each object.

15. The method of claim 14, wherein said graphical element comprises at least one of an object template, a line type or a line color.

16. A method for automatically analyzing a facility plan, comprising:
receiving the facility plan as an electronic drawing;
determining a plan from said electronic drawing;
analyzing said plan to determine at least one space;
extracting a plurality of objects from said plan;
identifying at least one object of said plurality of objects according to at least one rule; and
correlating said identified object with a spatial location in said at least one space.

17. The method of claim 16, wherein said identifying at least one object comprises identifying a plurality of objects, the method further comprising:
correlating a relative spatial location of each of said plurality of identified objects.

18. The method of claim 17, the method further comprising:
comparing said relative spatial location to at least one rule;
if said relative spatial location does not fit said at least one rule, re-identifying at least one object.

19. The method of claim 18, wherein said at least one rule comprises a rule modifier for determining a range of spatial locations.

20. The method of claim 16, further comprising:
identifying text corresponding to said identified object; and
extracting information about said identified object from said text.

21. The method of claim 20, wherein said information is compared to said identified object according to at least one rule, such that if said information does not correspond to said at least one rule, the method further comprises re-identifying said object.

22. The method of claim 16, wherein said analyzing said plan further comprises identifying a plurality of layer of said plan from said electronic drawing;
and wherein said identifying said at least one object comprises identifying the layer of said at least one object.

23. The method of claim 22, wherein said at least one layer features a layer template, said layer template being identified according to at least one other object identification, wherein said at least one object is identified according to said layer template.

24. The method of claim 16, wherein said at least one rule comprises at least one of a line color or line type.

25. The method of claim 16, wherein the facility plan includes at least one facility system and wherein said identifying at least one object comprises identifying a plurality of objects, the method further comprising:
determining a relationship between said plurality of objects; and
identifying said plurality of objects as belonging to a facility system according to said relationship.

26. The method of claim 25, wherein said relationship comprises a physical relationship, a logical relationship or a combination thereof.

27. The method of claim 25, wherein the facility plan comprises a plurality of facility systems, the method further comprising:
identifying a plurality of objects as belonging to each of said plurality of facility systems; and
identifying a relationship between said plurality of facility systems according to a relationship between a plurality of objects in said systems.

28. The method of claim 16, wherein the facility plan includes at least one facility system and wherein said identifying at least one object comprises identifying a plurality of objects, the method further comprising:
determining a relationship between said plurality of objects;
comparing said relationship to at least one rule;
identifying said relationship as an incorrect relationship; and
determining a mis-identification for at least one object according to said incorrect relationship.

29. The method of claim 16, further comprising:
enabling a user to change at least one aspect of an object identification or a plan, or both.

30. The method of claim 16, wherein said determining said plan further comprises:
identifying at least one floor in said plan;
determining a perimeter of said at least one floor according to a plurality of vectors.

31. The method of claim 30, wherein said determining said perimeter further comprises:
moving along said perimeter according to a first vector;
if a further point is no longer available, determining whether an opening is available; and
if an opening is not available, then moving along said perimeter according to a second vector, wherein said first vector and said second vector differ.

32. The method of claim 31, wherein said opening is available if a gap is present of less than a maximum size.

33. The method of claim 31, wherein said determining said perimeter further comprises:
moving along said perimeter in a clockwise direction; and
returning in a counterclockwise direction if said second vector is not available.

34. The method of claim 31, wherein said determining said plan of at least one floor further comprises:
comparing said perimeter to at least one rule;
if said perimeter does not fit said at least one rule, rejecting said perimeter.

35. The method of claim 34, wherein said at least one rule comprises an area range for said perimeter or a location of a fixed object within said perimeter.

36. The method of claim 35, wherein said fixed object comprises at least one of an elevator, a stairwell or an atrium.

37. The method of claim 16, wherein said analyzing said plan comprises:
determining a perimeter of at least one room according to a plurality of vectors.
